(19) United States
(12) Patent Application Publication
(10) Pub. No.: US 2007/0237242 A1
(43) Pub. Date: Oct. 11, 2007

(54) Multi Gigahertz High Capacity Digital Radio Frequency (Rf) Link Transceiver Terminal Assembly, and Method for Same

(76) Inventor: Karl Martin Gjertsen, Fana (NO)

Correspondence Address: YOUNG & THOMPSON, 745 SOUTH 23RD STREET, 2ND FLOOR, ARLINGTON, VA, 22202, US

(21) Appl. No.: 11/632,846

(22) PCT Filed: Jul. 21, 2005
(86) PCT No.: PCT/NO05/00277

§ 371 Date: May 17, 2007

(30) Foreign Application Priority Data
Jul. 21, 2004 (NO) 20043135

(51) Int. Cl. H04B 7/00

(52) U.S. Cl. 375/242

(57) ABSTRACT

A multi gigahertz digital radio frequency (RF) link terminal arrangement includes an indoor unit and an outdoor unit, interconnected by at least one high bandwidth communications element adapted to carry in a transmit direction a digital signal to be transported by the radiolink and in a receive direction an intermediate frequency digital RF receive signal to be transported by the radiolink. The outdoor unit includes an RF digital modulator integrated with a multi gigahertz digital RF amplifier assembly and at least two multi gigahertz digital RF receiver circuit assemblies, each having a multi gigahertz digital RF receive signal input and outputs for providing a respective one of a intermediate frequency digital RF receive signal. The indoor unit includes at least two RF digital demodulators having each an input for receiving at least one of the intermediate frequency digital RF receive signals, the RF digital demodulators adapted to exchange signal demodulation processing data.

### FIELD OF INVENTION

The field of application for the present invention may generally be labelled “high capacity microwave radio”, and more specifically such kind of microwave radio link solutions that offer very high quality, very high reliability, point-to-point or point-to-multipoint communication with capacities beyond 8 Mb/s wireless communication at microwave frequencies. In the context of the present invention, microwave frequencies are understood to include the range 3 GHz to 100 GHz.

The field of interest is in particular described in terms of the variability and complexity of the possible installations, ranging from single channel solutions without interaction with other radios to more complex installations requiring access to more than one receive signal for successful operation. Application like MIMO systems (Multiple Input, Multiple Output) and future interference mitigation solutions are considered to be of relevance to the present invention.

### KNOWN SOLUTIONS AND PROBLEMS WITH THESE

High capacity radio systems serve a variety of communication needs, and the great range of potential applications makes it natural to explain this invention in the light of technology and logistics, reflecting the kind of problem it aims to solve. The traditional applications are described by Freeman, Roger L., “Radio System Design for Telecommunications”, Second Edition (New York: John Wiley & Sons, 1997), giving an introduction to the application background for the invention.

¹ Norwegian patent application no 20034776, filed 24 Oct. 2003

When making radio systems for trunk and mobile backhaul point-to point communication, it turns out that the conventional arrangement of the functional units does not allow exploitation of technology advances for efficient radio transmitters. Point-to point high capacity radios operate at high frequencies, traditionally requiring line-of sight between the two antennas. The antennas often have to be placed in towers or other inconvenient locations with respect to access and maintenance. It is often highly desirable to have the transmit power amplifier as close to the antenna as possible in order to avoid power loss. For the same reason it is desirable to have the receive low-noise amplifier close to the antenna.

The split of radio installations into an outdoor unit and an indoor unit is natural. The outdoor unit should be robust and as simple as possible, and if one can afford the losses by separating the antenna from the transmit power amplifier and the receiver low noise amplifier, we may find that only the antenna belongs to the outdoor unit. For solutions in a product portfolio where this is not always the case, it has become common to designate all functional units that may need to be located outdoors in some installations as outdoor functions. As we only need to have channel frequency specific hardware in the outdoor functions, it has become common practice to class all channel frequency dependant hardware as outdoor functions, assuming communication with functions in the indoor unit at one or more fixed frequencies. The importance of this interface solution is shown by the fact that the outdoor unit actually includes the functional units on the antenna side of the abovementioned fixed frequency interface, regardless of whether these functional units are placed indoors or outdoors, meaning that what is typically referred to as the outdoor unit can in fact be distributed as, for example, an outdoor antenna and an indoor transceiver. Likewise would all functional units separated from the antenna by the abovementioned fixed frequency interface belong to the indoor unit.

This fixed, typically intermediate frequency interface between the outdoor unit and the indoor unit enables a standardization that makes the indoor unit hardware frequency independent. The implementation also is very effective. In the outdoor unit one only needs to shift the frequencies between the specific radio channels and the selected intermediate frequencies. The modulator and the demodulator of the indoor unit are not more costly due to the extra frequency conversion. Adding management messages and power supply to the same cable effectively completes a general interface allowing very flexible product arrangements.

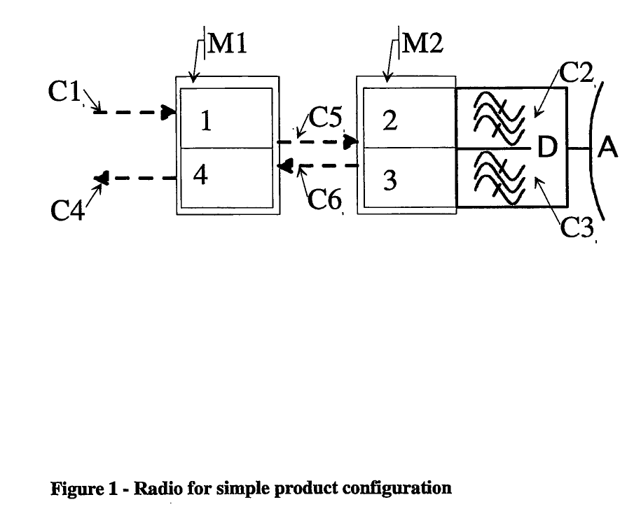

An illustration of this basic arrangement is provided in FIG. 1, giving the opportunity to define some terminology useful for the following descriptions. At the far right, an antenna is indicated in location A, closely connected to a frequency separation solution, marked D. The frequency separation solution can be a diplexer or more complex branching arrangements. The signal prepared for wireless transmission, C2, and the received signal, C3, from the antenna are identified here. To the left of the frequency separation solution (D), we find two functional units, numbered 2 and 3, and collectively labeled M2 as an abbreviation for “module 2”, often named a transceiver. Functional unit 2 performs frequency translation and amplification of the transmit signal, while functional unit 3 performs low-noise amplification and frequency translation of the receive signal. The outdoor unit hence contains the units labeled A, D and M2. The functional units 2 and 3 are kept together in a common module because they represent units that are most likely to need service in the outdoor unit, and efforts have been made to ease replacement service by non-specialists. Depending on product, M2 and D may be integrated as well.

The module M1 is part of the indoor unit of the radio system, containing the modulator unit 1 and the demodulator unit 4 for the specific radio. The interface towards the outdoor unit is as described above. We identify the transmit signal, C5, and the received signal, C6, both having chosen, fixed frequencies. A cable based connection, covering distances from 1 to 300 meters between M1 and M2 provides an effective communication solution. Input digital data for wireless transmission, labeled C1, are received in the modulator unit 1. Output digital data, demodulated from the received signal, are provided from the demodulator 4, at the interface labeled C4.

There is significant cost associated with the generation of the transmit signal with required quality. Recent developments, such as what is disclosed in Norwegian patent application no 20034776, filed by the present applicant on 24 Oct. 2003, have created further potential for improvement in the transmit chain, having an important impact on system cost, output power, linearity and efficiency of the power amplifier. To take full advantage of these advancements, the modulator unit 1 and the circuits at channel frequency, including the power amplifier, must work in close cooperation, which in turn requires physical proximity. Known arrangements (radio architectures) are not capable of taking full advantage of such solutions due to the physical distances that traditionally separate the indoor unit from the outdoor unit, which may be as large as up to 300 meters. Until now, the skilled person in the art has chosen the obvious solution to this problem, namely to move both modulator and demodulator to the outdoor unit, thereby eliminating the interfaces at C5 and C6. Thus, by communication of the input data and the output data at C1 and C4, respectively, directly to the outdoor unit, as known from in present day technology, a straightforward solution is available. This straightforward solution, however, does not address the thereby incurred problems of maintainability and other important operational aspects, which all tend to add cost and other design considerations in order to meet the stringent performance requirements that typically are presented by radio link operators.

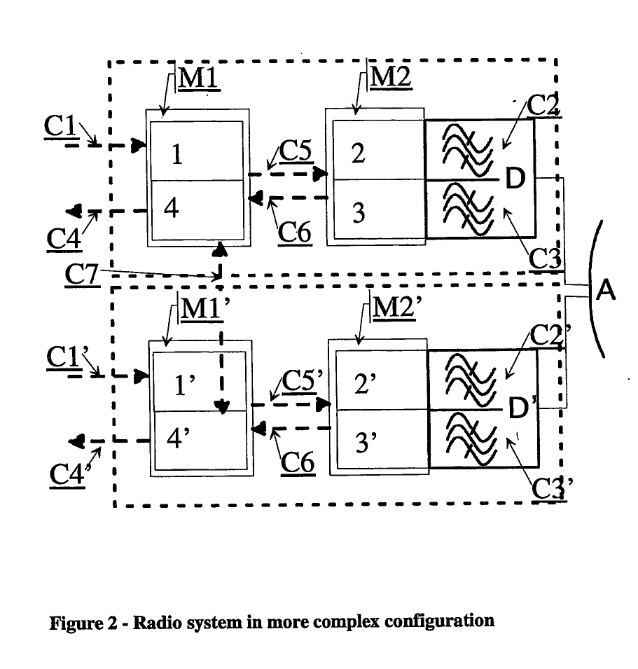

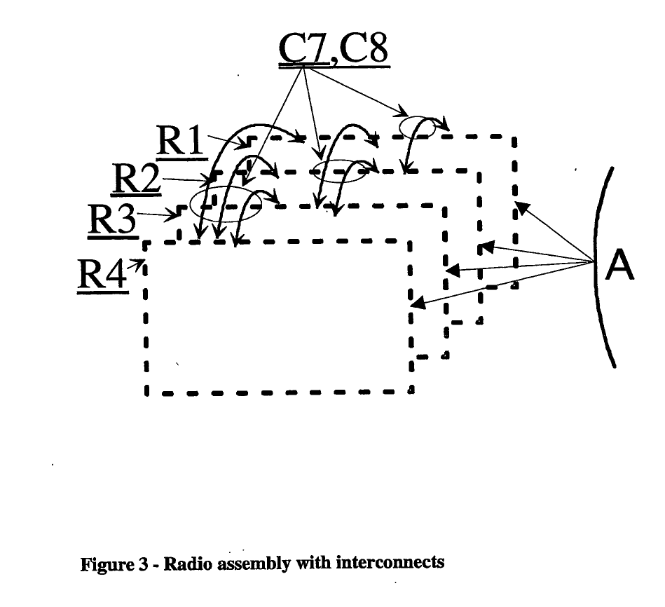

Furthermore, in installations with more than one radio channel, quality and availability requirements, in conjunction with the desire to utilize the spectrum as efficiently as possible, often require the demodulators to cooperate. One example of this is the use of two, or even more, polarizations in a radio link. Briefly, the antennas are arranged to excite and receive signals at, for example, orthogonal polarizations, thereby multiplying the spectrum utilization. However, in the case of orthogonal polarization, perfect orthogonality is a rare event, and there is need for interference mitigation in order to arrive at the expected performance. If a demodulator receives the signal from both polarizations, it is possible to solve this task. The traditional solution to this is illustrated in FIG. 2, being characterized by the need to exchange the received signal between the two demodulators. This transfer of received signals is labeled C7. Other arrangements exist, requiring similar transfers of signals, giving cross connections similar to what is shown in FIG. 3. One or more antennas may be used. The essential feature is that some of the demodulators need access to the receive signals from one or more other receivers.

If the demodulators are placed in respective outdoor units for such system arrangements, then cross-links between the demodulators outdoors must to be provided. It is clear that such an arrangement will incur significant costs.

To date, the industri has tried to improve the transmit chain cost and performance for complex radio installations without taking advantage of the potential associated with close connection between the modulator and channel frequency dependant hardware, including the power amplifier. The inventors of the present invention do not know of any previously known solution to this challenge of the type disclosed herein.

### BRIEF DESCRIPTION AND OBJECTS OF THE INVENTION

According to the present invention, it is proposed to separate the modulator and demodulator units, whereby it becomes possible to take advantage of benefits in the transmit chain while maintaining the advantages of having an indoor demodulator. The idea of such a separation results in some complications to be overcome. The choice to do so and the measures taken to overcome the associated obstacles are material to the invention.

The major benefits become apparent when a complete product portfolio is to be created that supports a variety system solutions that range from from single channel radios with just one transmitter and one receiver to complex systems that for performing one or more demodulation tasks require access to more than one of the received radio signals. The typical solution of optimised hardware for the different configurations is not a viable alternative, as customers often want flexibility and options for further expansion, and because the average number of installations per configuration typically is limited.

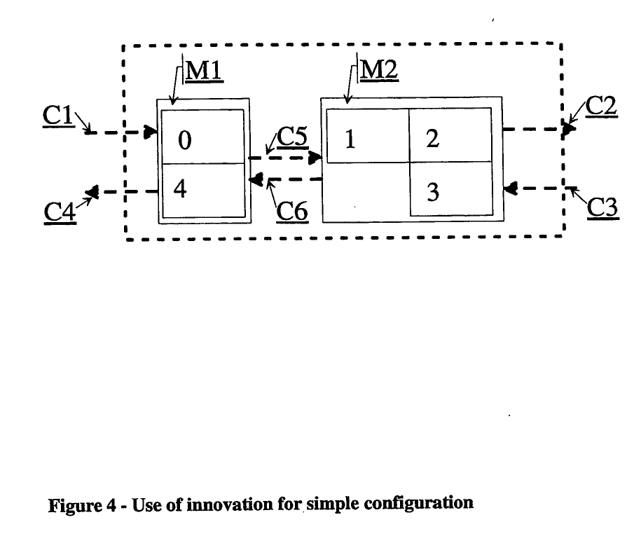

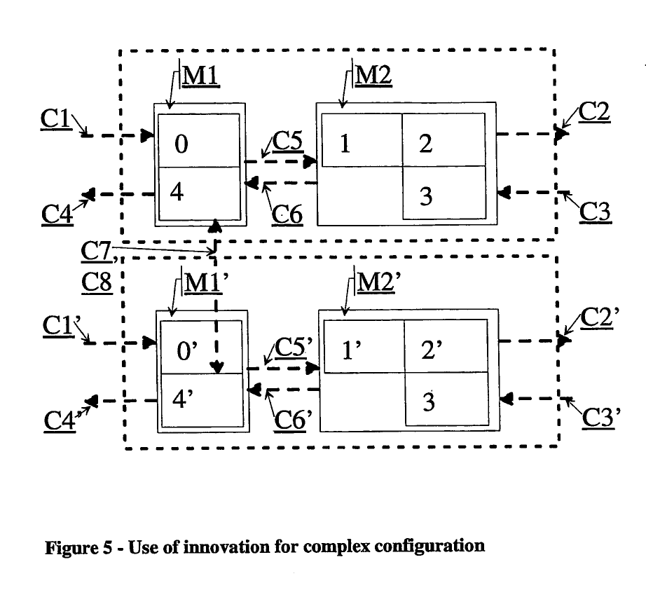

In order to arrive at a solution that enables a common hardware platform to support all configurations of interest in a cost effective manner, it is an important choice not to integrate the frequency separating unit with the module M2, as seen in FIG. 4 and FIG. 5, where the transmit and receive signals are simply labelled C2 and C3. This enables assembly of simple, diplexer based, installations using the same modules as those employed in more complex solutions that are based on branching.

A further object of the invention is to take advantage of a common mechanical solution. Such a solution must cope with all product configurations, including variants with high output power that may have demanding thermal requirements. Exploitation of the integrated transmit chain and the solution disclosed in Norwegian patent application no 20034776, filed 24 Oct. 2003, to obtain maximum power efficiency by means of e.g. dynamic biasing schemes in installations requiring high output power, eases the thermal requirements significantly. In the context of the present invention, this new technology further enhances the enablement of one common mechanical solution for a complete product range that does not add what previously has been considered unacceptable cost.

In a first aspect, the present invention provides a multi gigahertz digital radio frequency (RF) link terminal arrangement comprising an indoor unit and an outdoor unit interconnected by at least one high bandwidth communications means for carrying in a transmit direction a digital signal to be transported by said radiolink and in a receive direction an intermediate frequency digital RF receive signal to be transported by said radiolink. The outdoor unit includes an RF digital modulator integrated with a multi gigahertz digital RF amplifier assembly, said RF digital modulator having an input adapted for receiving said digital signal to be transmitted by said radiolink, and at least two multi gigahertz digital RF receiver circuit assemblies adapted for receiving a multi gigahertz digital RF receive signal and having an output each for providing a respective one of said intermediate frequency digital RF receive signal. The indoor unit including at least two RF digital demodulators having each an input adapted for receiving at least one of said respective one of said intermediate frequency digital RF receive signal. The at least two RF digital demodulators are provided with a means for exchanging signal demodulation processing data to allow mutual optimization of demodulation of said intermediate frequency digital RF receive signal.

In a further aspect, the present invention provides provides a multi gigaherz radio link terminal as recited in any one of the accompanying patent claims.

In a further aspect, the present invention provides an architecture for a multi gigaherz radio link terminal suitable for use in highly different product configurations.

In a further aspect, the present invention provides provides a multi gigaherz radio link terminal having the modulator in module M2 and the demodulator in module M1, with the following interface features: Data to be transmitted are received in M1 and transported to M2, where modulation takes place. The received waveform in M2 is transported to M1 and is available at a suitable interface for transfer to the M1 modules of other radios.

In a further aspect, the present invention provides provides a multi gigaherz radio link terminal wherein the demodulator is equipped to receive waveforms from one or more other M1 modules to support successful demodulation. In specific configurations, obsolete functional units may be removed.

In a further aspect, the present invention provides provides a multi gigaherz radio link terminal intended for product portfolios covering frequencies above 3 GHz RF.

In a further aspect, the present invention provides provides a multi gigaherz radio link terminal providing communications using radio bandwidths of at least 2.5 MHz as measured in C2 or C3

In a further aspect, the present invention provides provides a high capacity multi gigaherz radio link terminal supporting communications at high data rates.

In a further aspect, the present invention provides provides a multi gigaherz radio link terminal arrangement adapted to support products portfolios where the distance between M1 and M2 may be in the range 1 to 300 meters.

In a further aspect, the present invention provides provides a multi gigaherz radio link terminal using a cable modem to provide all communication between M1 and M2 in digital format.

In a further aspect, the present invention provides provides a multi gigaherz radio link terminal that is usable in a selection of embodiments that are flexibility to serve as a single radio, in a Space Diversity configuration, in an XPIC configuration, in a configuration with Space Diversity and XPIC, any of these connecting to either a diplexer or a branching network, and allowing High-power variants in the same mechanics.

In a further aspect, the present invention provides provides a multi gigaherz radio link terminal that allows the interchange of waveforms not restricted to Space Diversity and XPIC applications.

The present invention provides a method for sending a first digital data signal and receiving a second digital data signal using a multi gigahertz digital radio frequency (RF) link terminal arrangement comprising a first outdoor unit (M2), a first indoor unit (M1), and at least one high bandwidth communications means (C5, C6) interconnecting said outdoor and indoor units, the method comprising:
a) in said first indoor unit,
a.1) receiving said first digital data signal at a digital data signal input (C1), modulating said first digital data signal by a modulator part (0) of a first modem to obtain a first modulated digital data signal, and transferring said first modulated digital data signal via said high bandwidth communications means to said outdoor unit, and
a.2) receiving an intermediate frequency digital RF receive signal via said high bandwidth communications means and adapting by an first adapter means said received intermediate frequency digital RF receive signal, inputing to an RF digital demodulator (4) said adapted intermediate frequency digital RF receive signal input, demodulating by said RF digital demodulator (4) said adapted intermediate frequency digital RF receive signal to obtain said second digital data signal, and outputing on said second digital data signal on an output (C4), and
b.) in said first outdoor unit:
b.1) receiving and demodulating by a demodulator part (1) of said first modem means said first modulated digital data signal transferred to said indoor unit via said high bandwidth communications means to obtain said first digital data signal, generating by an RF digital modulator and multi gigahertz digital RF amplifier assembly (2) a high capacity multi gigaherz RF transmit signal and outputing said transmit signal on a multi gigahertz digital RF transmit signal output (C2), and demodualting by a demodulator part (1) of said first modem means providing an adaptation between said input of said assembly (2) and said high bandwidth communications means (C5), and
b.2) receiving by a multi gigahertz digital RF receiver circuit (3) a multi gigahertz digital RF receive signal and providing on an output said intermediate frequency digital RF receive signal, and adapting by a second adapter means said output of said intermediate frequency digital to said high bandwidth communications means (C6).

The method of the invention further includes providing a second multi gigahertz digital radio frequency (RF) link terminal arrangement comprising a second outdoor unit (M2′), a second indoor unit (M1′), and at least one second high bandwidth communications means (C5′, C6′) interconnecting said second outdoor and indoor units,
providing a connection between said RF digital demodulator (4) and a second RF digital demodulator (4′) of said second second indoor unit for exchanging of RF signal demodulation processing data,
said RF digital demodulator (4) of said first indoor unit having a first signal demodulation processing data input connectable to said second signal demodulation processing data output (C7), and
adapting said first or second RF digital demodulator (4,4′) of said first indoor unit to perform demodulation of said intermediate frequency digital RF receive signal in response to signal demodulation processing data exhanaged from said second or first RF digital demodulator (4′,4), respectively.

The method of the invention further includes signal handling, signal processing and signal transfer by way of an arrangement according to any one of the accompanying multi gigahertz digital radio frequency (RF) link terminal arrangement claims.

### DETAILED DESCRIPTION AND EXEMPLARY EMBODIMENTS OF THE INVENTION

The novel arrangement, having the modulator in the outdoor unit and the demodulator in the indoor unit, as shown in FIG. 4 and FIG. 5, is a prominent characteristic of the present invention. By this arrangement, the present invention teaches against the bias of prior art solutions which define the interface traditionally used between the indoor unit and the outdoor unit to be the only way for obtaining an efficient and attractive solution in the field of the present invention.

A new interface introduced between the indoor unit and the outdoor unit would represent an additional complexity, with cost implications. Therefore, the present invention represents and identifies a solution that adds little enough cost to make the change very attractive. Furthermore, the actual interface solution that is chosen for the invention can be embodied in anumber of different ways, as any interface solution that is appropriate for bringing the transmit data to the outdoor unit and the receive signal to the indoor unit within acceptable cost is considered part of an embodiment of the present invention.

A first example of an interface foran employment of the invention lies in the introduction of a cable modem to transfer transmit data from the indoor unit to the outdoor unit, essentially enabling the same physical solutions for connecting the indoor unit with the outdoor unit. In the indoor unit, a new functional unit, labeled 0, is added, which modulates the digital data C1 to create a cable transmit signal C5 for transfer to the outdoor unit. In the outdoor unit, the functional unit 1 is extended, due to the fact that demodulation has to be performed for restoring the digital data fed into the modulator, which, according to the invention is placed in close interaction with the microwave transmitter. Thus, to obtain a separation of the demodulator from the modulator in this solution, an extra cable modem has been added.

By a further development of the interface solution, management communication is integrated into the modem solution for transmit data, simplifying multiplexing tasks and making previous management communication solutions obsolete.

An embodiment of the present invention where the capacity of the cable modem allows transmission of a digitized version of the receive signal, is yet another attractive solution, as the need for frequency separation on the medium between the indoor unit and the outdoor unit is completely removed.

Some variants of the present invention are illustrated by the accompanying, starting with the fact that the novel architecture enables the offering of a complete range of radio configurations based on the same hardware elements when technical specifications, such as frequency and output power, are kept the same. This gives major benefits in terms of development effort, logistics cost and overall manufacturing cost.

The placement of the demodulator indoors enables the configuration flexibility for both simple and complex systems.

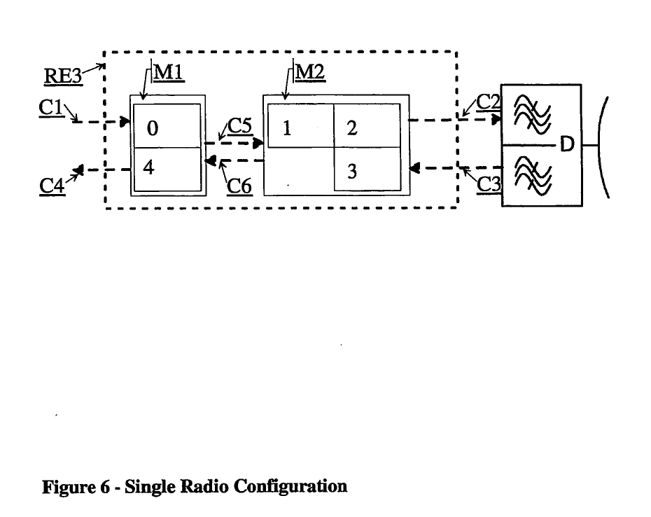

FIG. 6 shows a simple system solution embodiment, which embodiment by itself is not at a cost optimum. However, it offers to the customer the option to make a low-entry cost investment with a high degree of freedom for reuse in a future expansion of the link.

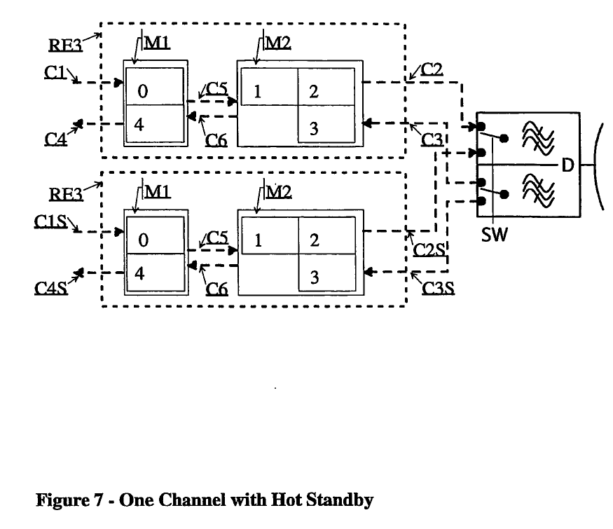

FIG. 7 shows a more complex system embodiment, where a further radio is added to provide hardware redundancy. The freedom to reconfigure the hardware resources is high.

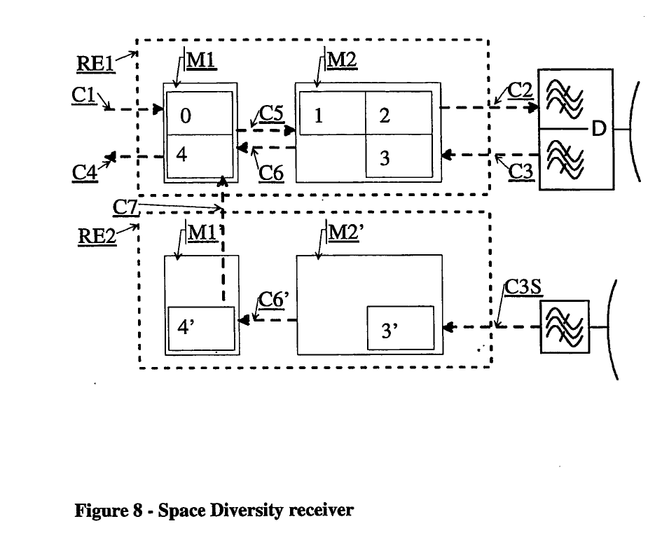

FIG. 8 shows an embodiment of the invention with a space diversity receiver radio arrangement. This is the first of several configurations disclosed here where the indoor placement of the demodulator proves important. The basic benefit of such a system is mitigation of selective (multipath) fading by using two antennas.

In a traditional approach, the functional blocks in the transmit direction can be removed from one of the radios, including the transmission solution from M1 to M2. If a full radio is installed in both radios, it is possible to have full hardware redundancy as well, and even envision the extension to a MIMO system.

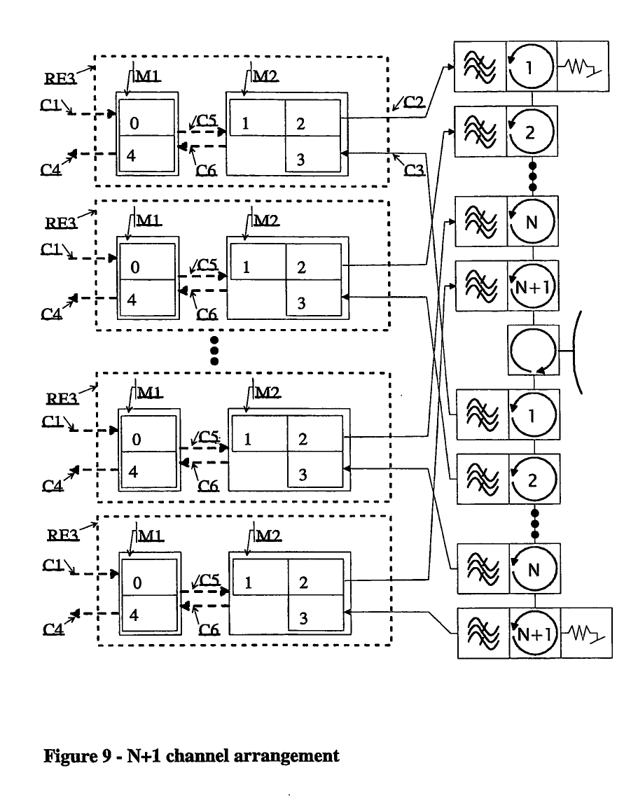

FIG. 9 is a schematic drawing that shows an example of a significantly more complex system embodiment of the present invention, that utilizes a common antenna for simultaneous communication at N radio channels, with one radio as a redundant hardware element. In this example, it is essential not to have the diplexer integrated with unit M2 (transceiver).

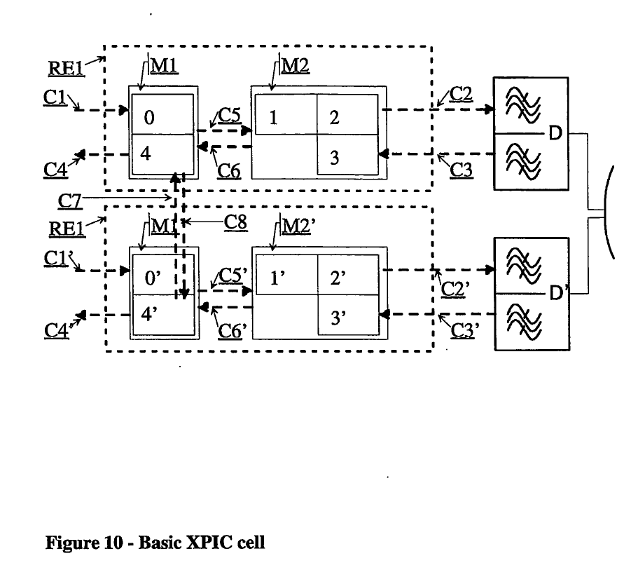

FIG. 10 is a schematic drawing that shows an example of an XPIC installation (cross polarization interference cancellation solution). In this example, the exchange of receive signals is used to its full extent. This solution has very high value, as it doubles the capacity within the same frequency slot.

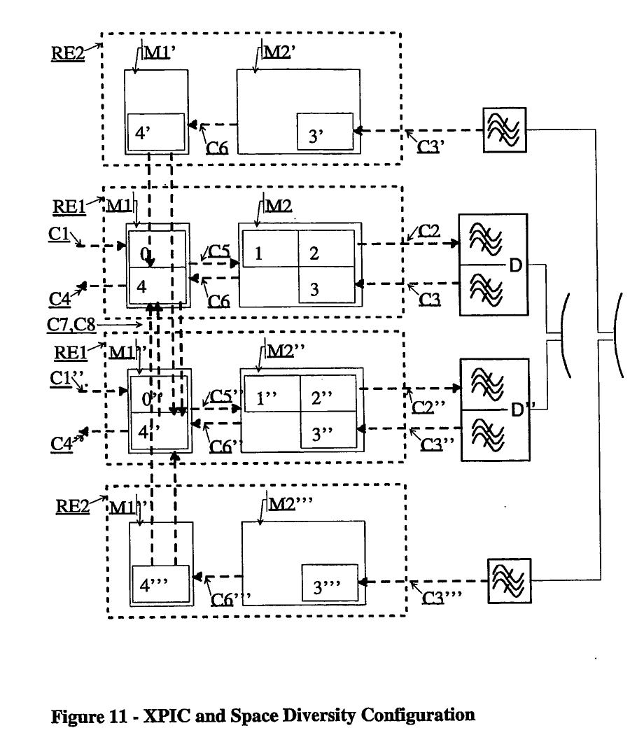

FIG. 11 is a schematic drawing that shows an installation that combines Space Diversity and XPIC. It shows a system with extended use of the capability to transfer receive signals to other radios. The opportunity to be able to combine information from several receive signals is essential to meet performance requirements presented by demanding customers.

For all of the exemplary radio installations illustrated by way of the FIGS. 6 through 11, and as otherwise disclosed herein, variations for coping with conditions calling for high power variants of the transmitters in order to cope with longer hops, difficult climate etc. are contemplated. Such variants are likely to be more costly, due to, for example, the fact that the power amplifier would require the use of components that provide enhanced perfomance.

Furthermore, it is realized by the present inventors that, if there also is a need for different mechanics, such as, for example, to cope with heat removal, the cost for the product portfolio may rise by another order of magnitude. For this reason it is extremely important to base new link terminals on the novel architecture of the present invention, in order to take advantage of the option for enhanced efficiency offered by the integrated modulator and transmitter in this new architecture.

For providing efficient demodulation, and to minimise demodulation errors, the demodulators of a multi gigahertz RF terminal according to the invention is provided with an interface for exchanging demodulation processing data related to demodulation of an intermediate RF signal being input to the modulator. The exchange of demodulation processing data can be arranged to be made in one direction from a first demodulator to a second modulator included in the same indoor unit (IDU), or as a biderectional exchange of demodulation processing data. In case more than two demodulators are included in the same IDU, or in co-located IDUs, all of which IDUs being arranged to provide the same signal, a demodulator in one of said IDUs may be provided with an interface for sending to, or receiving from, a plurality of said demodulators the demodulation processing data. The digital demodulator will employ appropriately designed demodulation processing, designed to take into account the information received from other demodulators to obain the best possible demodulation result.

1. A multi gigahertz digital radio frequency (RF) link terminal arrangement for a digital multi gigahertz RF link, said RF terminal arrangement comprising an indoor unit (IDU) and an outdoor unit (ODU), said IDU and ODU being physically separate from each other and interconnected by a high bandwidth communications means being adapted to carry in a transmit direction, in the form of a first digital signal, a transmit signal to be transported by said RF link and in a receive direction, in the form of first intermediate RF signals, a receive signal transported by said RF link, wherein
said ODU including
i) a multi gigahertz RF digital modulator integrated with a multi gigahertz RF amplifier assembly, said RF digital modulator having an input adapted for accepting via high bandwidth communications means said first digital signal, and
ii) at least two multi gigahertz digital RF receiver circuit assemblies being adapted for receiving a multi gigahertz digital RF receive signal and having each an output for providing via said high bandwidth communications means a respective one of said first intermediate RF signals, and
said IDU including at least two RF digital demodulators having each an input adapted for accepting via said high bandwidth communications means a respective one of said first intermediate RF signals.

2. The multi gigahertz digital RF terminal arrangement of claim 1, wherein said at least two RF digital demodulators being provided with a means for exchanging a receive signal waveform or demodulation processing data related to demodulation said respective one of said first intermediate RF signals.

3. The multi gigahertz digital RF terminal arrangement of claim 2, wherein at least one of said at least two RF digital modulators being adapted to optimize its demodulation said respective one of said first intermediate RF signals on basis of an exchanged receive signal waveform or demodulation processing data.

4. The multi gigahertz digital RF link terminal arrangement of claim 1, being built according to an architecture suitable for use in highly different product configurations.

5. The multi gigahertz digital RF link terminal arrangement of claim 1, having the modulator in module M2 and the demodulator in module M1, and with the following interface features:
Data to be transmitted are received in M1 and transported to M2, where modulation takes place; and
The received waveform in M2 is transported to M1 and is available at a suitable interface for transfer to the M1 modules of other radios.

6. The multi gigahertz digital RF link terminal arrangement of claim 1, wherein the demodulator is equipped to receive waveforms from one or more other M1 modules to support successful demodulation, and
wherein, in specific configurations, obsolete functional units may be removed.

7. The multi gigahertz digital RF link terminal arrangement of claim 1, being part of a product portfolis covering frequencies above 3 GHz RF.

8. The multi gigahertz digital RF link terminal arrangement of claim 1, adapted to provide communications using radio bandwidths of at least 2.5 MHz as measured in C2 or C3

9. The multi gigahertz digital RF link terminal arrangement of claim 1, adapted to support communications at high data rates.

10. The multi gigahertz digital RF link terminal arrangement of claim 1, adapted to support a product portfolio where the distance between M1 and M2 may is in the range of 1 meter to 300 meters.

11. The multi gigahertz digital RF link terminal arrangement of claim 1, further comprising a cable modem to provide all communication between M1 and M2 in digital format.

12. The multi gigahertz digital RF link terminal arrangement of claim 1, adaptable for use in a variety of embodiments providing flexibility to serve in at least one of a single radio, a Space Diversity configuration, an XPIC configuration, a configuration with Space Diversity and XPIC, and any one of these when connected to either a diplexer or a branching network, and allowing High-power variants in the same mechanics.

13. The multi gigahertz digital RF link terminal arrangement of claim 1, adapted to interchange of waveforms between demodulator units, said waveforms not restricted to Space Diversity and XPIC applications.

14. A multi gigahertz digital radio frequency (RF) link terminal arrangement comprising a first outdoor unit (M2), a first indoor unit (M1), and at least one high bandwidth communications means (C5, C6) interconnecting said outdoor and indoor units, wherein
said first indoor unit including:
a digital data signal input (C1),
a modulator part (0) of a first modem means providing an adaptation between said digital data signal input and said high bandwidth communications means,
an RF digital demodulator (4) having an intermediate frequency digital RF receive signal input and a digital data signal output (C4),
and first adapter means providing an adaptation between said high bandwidth communications means (C6) and said intermediate frequency digital RF receive signal input, and
said first outdoor unit including:
an RF digital modulator and multi gigahertz digital RF amplifier assembly (2), said assembly (2) having an input and a multi gigahertz digital RF transmit signal output (C2),
a demodulator part (1) of said first modem means providing an adaptation between said input of said assembly (2) and said high bandwidth communications means (C5),
a multi gigahertz digital RF receiver circuit (3) having a multi gigahertz digital RF receive signal input (C3) and an output for providing said intermediate frequency digital RF receive signal, and
a second adapter means for providing an adaptation between said output of said multi gigahertz digital RF receiver circuit and said high bandwidth communications means (C6).

15. The multi gigahertz digital RF link terminal arrangement of claim 14, further comprising a second outdoor unit (M2′), a second indoor unit (M1′), and a second high bandwidth communications means (C6′) interconnecting said second outdoor and second indoor units, wherein
said second indoor unit including:
an RF digital demodulator (4) having a second intermediate frequency digital RF receive signal input and a second signal demodulation processing data output (C7), and
a third adapter means providing an adaptation between said second high bandwidth communications means (C6′) and said second intermediate frequency digital RF receive signal input, and
said outdoor unit including:
a second multi gigahertz digital RF receiver circuit (3′) having a second multi gigahertz digital RF receive signal input (C3′) and an second output for providing said second intermediate frequency digital RF receive signal, and
a fourth adapter means for providing an adaptation between said second output of said multi gigahertz digital RF receiver circuit and said second high bandwidth communications means (C6′).

16. The multi gigahertz digital RF link terminal arrangement of claim 15, wherein
said RF digital demodulator (4) of said first indoor unit having a first signal demodulation processing data input connectable to said second signal demodulation processing data output (C7), and
said RF digital demodulator (4) of said first indoor unit being adapted to perform demodulation of said intermediate frequency digital RF receive signal in response to said second signal demodulation processing data.

17. The multi gigahertz digital RF link terminal arrangement of claim 15, wherein said RF digital demodulator (4) of said first indoor unit having a first signal demodulation processing data output (C8),
said second RF digital demodulator (4′) of said second indoor unit having a second signal demodulation processing data input connectable to said first signal demodulation processing data output (C8), and
said second RF digital demodulator (4′) being adapted to perform demodulation of said second intermediate frequency digital RF receive signal in response to said first signal demodulation processing data.

18. A method for sending a first digital data signal and receiving a second digital data signal using a multi gigahertz digital radio frequency (RF) link terminal arrangement comprising a first outdoor unit (M2), a first indoor unit (M1), and at least one high bandwidth communications means (C5, C6) interconnecting said outdoor and indoor units, the method comprising:
a) in said first indoor unit,
a.1) receiving said first digital data signal at a digital data signal input (C1),
modulating said first digital data signal by a modulator part (0) of a first modem to obtain a first modulated digital data signal, and transferring said first modulated digital data signal via said high bandwidth communications means to said outdoor unit, and
a.2) receiving an intermediate frequency digital RF receive signal via said high bandwidth communications means and adapting by an first adapter means said received intermediate frequency digital RF receive signal, inputing to an RF digital demodulator (4) said adapted intermediate frequency digital RF receive signal input, demodulating by said RF digital demodulator (4) said adapted intermediate frequency digital RF receive signal to obtain said second digital data signal, and outputing on said second digital data signal on an output (C4), and
b.) in said first outdoor unit:
b.1) receiving and demodulating by a demodulator part (1) of said first modem means said first modulated digital data signal transferred to said indoor unit via said high bandwidth communications means to obtain said first digital data signal, generating by an RF digital modulator and multi gigahertz digital RF amplifier assembly (2) a high capacity multi gigaherz RF transmit signal and outputing said transmit signal on a multi gigahertz digital RF transmit signal output (C2), and demodualting by a demodulator part (1) of said first modem means providing an adaptation between said input of said assembly (2) and said high bandwidth communications means (C5), and
b.2) receiving by a multi gigahertz digital RF receiver circuit (3) a multi gigahertz digital RF receive signal and providing on an output said intermediate frequency digital RF receive signal, and adapting by a second adapter means said output of said intermediate frequency digital to said high bandwidth communications means (C6).

19. The method of claim 18, further including
providing a second multi gigahertz digital radio frequency (RF) link terminal arrangement comprising a second outdoor unit (M2′), a second indoor unit (M1′), and at least one second high bandwidth communications means (C5′, C6′) interconnecting said second outdoor and indoor units,
providing a connection between said RF digital demodulator (4) and a second RF digital demodulator (4′) of said second second indoor unit for exchanging a receive signal waveform or signal demodulation processing data,
said RF digital demodulator (4) of said first indoor unit having a first signal demodulation processing data input connectable to said second signal demodulation processing data output (C7), and
adapting said first or second RF digital demodulator (4,4′) of said first indoor unit to perform demodulation of said intermediate frequency digital RF receive signal in response to signal demodulation processing data exhanaged from said second or first RF digital demodulator (4′,4), respectively.

20. The method of claim 18, further including signal handling, signal processing and signal transfer by way of a multi gigahertz digital RF terminal arrangement comprising an indoor unit (IDU) and an outdoor unit (ODU), said IDU and ODU being physically separate from each other and interconnected by a high bandwidth communications means being adapted to carry in a transmit direction, in the form of a first digital signal, a transmit signal to be transported by said RF link and in a receive direction, in the form of first intermediate RF signals, a receive signal transported by said RF link, wherein
said ODU including
i) a multi gigahertz RF digital modulator integrated with a multi gigahertz RF amplifier assembly, said RF digital modulator having an input adapted for accepting via high bandwidth communications means said first digital signal, and
ii) at least two multi gigahertz digital RF receiver circuit assemblies being adapted for receiving a multi gigahertz digital RF receive signal and having each an output for providing via said high bandwidth communications means a respective one of said first intermediate RF signals, and
said IDU including at least two RF digital demodulators having each an input adapted for accepting via said high bandwidth communications means a respective one of said first intermediate RF signals.

21. The multi gigahertz digital RF link terminal arrangement of claim 16, wherein said RF digital demodulator (4) of said first indoor unit having a first signal demodulation processing data output (C8),
said second RF digital demodulator (4′) of said second indoor unit having a second signal demodulation processing data input connectable to said first signal demodulation processing data output (C8), and
said second RF digital demodulator (4′) being adapted to perform demodulation of said second intermediate frequency digital RF receive signal in response to said first signal demodulation processing data.
